(19) United States
(12) Patent Application Publication
(10) Pub. No.: US 2006/0294547 A1
(43) Pub. Date: Dec. 28, 2006

(54) System and method for forced commercial viewing

(76) Inventors: Bjorn Johannes Maria Bon, Helmond (NL); Jos Van Ginkel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,846

(22) PCT Filed: Sep. 1, 2004
(86) PCT No.: PCT/IB04/51667

§ 371 Date: Jul. 3, 2006

Related U.S. Application Data
(60) Provisional application No. 60/500,719, filed on Sep. 5, 2003.

(51) Int. Cl. H04N 7/10; H04N 7/025; H04N 5/445; G06F 13/00; H04N 7/16; G06F 3/00

(52) U.S. Cl. 725/46; 725/27; 725/34; 725/35

(57) ABSTRACT

A viewer's attention to televised advertisement (41, 43, 45) is encouraged by offering and providing the viewer (102) with a reward as an incentive to watch and/or interact with one or more commercial segments (41, 43, 45) of the broadcast. By providing such rewards to viewers, commercial advertisers on a broadcast are more reliably assured that the commercial segments are being viewed. The viewer may be rewarded the viewer (102) with the opportunity to watch an otherwise scrambled future broadcast at no charge. By transmitting an entitlement (EMM) message only during the commercial segments, a viewer (102) whose receiving device (e.g., set-top box) is tuned to the station broadcasting the commercial segment (41, 43, 45) will receive the EMM message required to descramble the future broadcast Further, the viewer may be required to participate or interact in some manner with the commercial segment to insure the viewer's presence.

The present invention relates generally to the field of broadcast and reception, and more particularly to a technique for providing rewards in accordance to a user's interaction behavior with a program service such as pay television.

One type of entertainment device that has experienced wide acceptance is the television. Television has become one of the most widespread mediums for broadcasting content to a viewer. Almost every house in the United States and in most other developed countries has access to a television. Families congregate around the television to enjoy movies, sitcoms, instructional programming, comedy shows, and more. Conventional television may receive its signals from a content broadcast source via cable, satellite, antenna, or other device. The channels are “tuned” either by the television itself or by a set top box. Content is provided by a plurality of content broadcast sources, in return for advertising revenue. One of the ways a content broadcast source derives revenue is through the sale of time slots for commercial advertising. A company promoter pays for a time slot during a particular broadcast, such as a movie or a sitcom, to promote a company product. The company promoter relies on the power of the advertisement to motivate each viewer either to travel to a store to purchase the product or to order the product via telephone or Internet connection. The TV commercials are strategically inserted into the regular TV programs and broadcasted at certain time intervals so that the television viewers who are interested in watching regular TV programs also watch inserted TV commercials. However, to the disappointment of the commercial advertisers, only an extremely small percentage of these viewers pay attention to these commercials. Furthermore, they tend to only watch commercials for products for which they have an immediate need, interest or curiosity. An associated problem in reaching a viewing audience for the purpose of advertising is the staggering number of viewing choices available today. Cable television systems typically offer one-hundred or more channels to viewer subscribers. As a result, it remains increasingly difficult to retain a viewer's attention during commercial segments. When a commercial segment appears, viewers are known to “channel surf”, i.e., jump from channel to channel to escape or avoid having to watch the commercial segments. A surfer will typically not spend more than two or three seconds on any one channel unless there is something on the screen at that precise moment which is of interest. Channels with commercials currently airing and most movies deemed to be well in progress are surfed over almost instantly with very little pause.

This leads to serious challenges to the TV content providers and broadcasters who are currently dependent on selling effective TV commercials for supporting their content creation and broadcasting. The effectiveness of the current TV commercial broadcasting model is challenged as a result.

Hence, there is a real need in the art for a system and method which overcomes the problem of viewers switching channels during commercial breaks to avoid having to watch the commercial segments.

The present invention provides a system and a method for encouraging a viewer's attention to televised advertisement. In brief, when a viewer is watching a currently televised broadcast, there is a risk that the viewer will “escape” to another channel to avoid watching the commercial segments of the broadcast. This problem is addressed by the invention by offering and providing the viewer with a reward as an incentive to stay tuned to the channel during the commercial segments. By providing such rewards to viewers, broadcast sponsors (i.e., commercial advertisers) are more reliably assured that the commercial segments they produce are being viewed.

According to an embodiment of the invention there is provided a system and method in which a content provider encourages a viewer to watch the commercial segments of a current broadcast by rewarding the viewer, such as with the opportunity to watch, at no charge, an otherwise scrambled future broadcast requiring a descrambling fee. In accordance with the embodiment, by transmitting the entitlement (EMM) message only during the commercial segments, a viewer whose receiving device is tuned to the pre-determined station (channel) of interest to the commercial advertiser offering the reward incentive, will receive the EMM message required to descramble the future broadcast at no charge. Conversely, a viewer who does not stay tuned to the channel during the commercial broadcast will not receive the EMM message and thus will not have the means necessary to descramble the subsequent broadcast free of charge.

In another embodiment, to overcome the problem of a viewer's set-top box being appropriately tuned to the broadcast station during the commercial segments while the viewer is elsewhere (i.e., not watching as expected), the viewer is required to participate or interact in some manner with the commercial segment to insure the viewer's presence. Interaction with the commercial segment may take any number of forms including, for example, but not limited to, filling in an electronic form including a viewer's profile to be transmitted to the content provider, requiring the viewer to play a game related to the product being endorsed in the commercial segment or requesting that the viewer fill in a barcode of an already purchased product to be transmitted to the content provider. In this manner, a broadcast sponsor (i.e., commercial advertiser) is assured that the viewer is attentive to the broadcasted commercial segments.

The foregoing features of the present invention will become more readily apparent and may be understood by referring to the following detailed description of an illustrative embodiment of the present invention, taken in conjunction with the accompanying drawings, where:

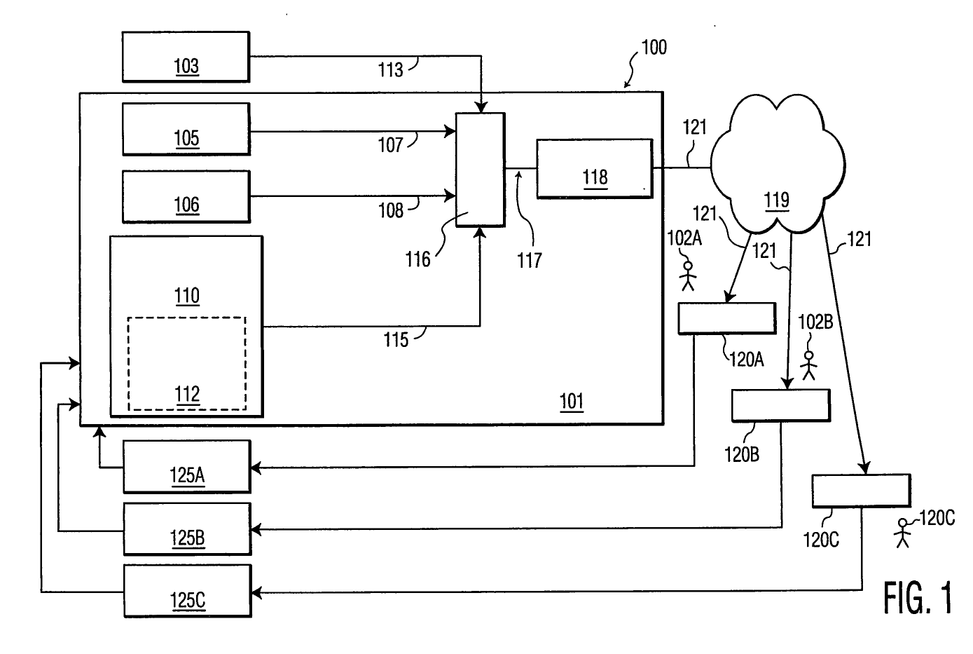

FIG. 1 is a schematic block diagram illustrating a system of the invention according to one embodiment,

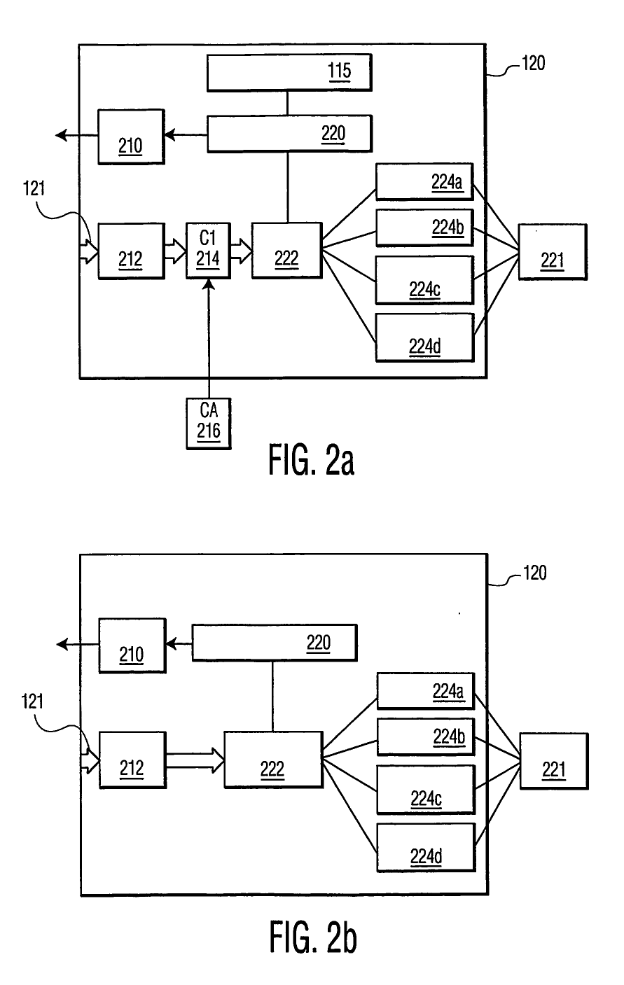

FIG. 2 is more detailed illustration of an integrated receiver device of the system of FIG. 1;

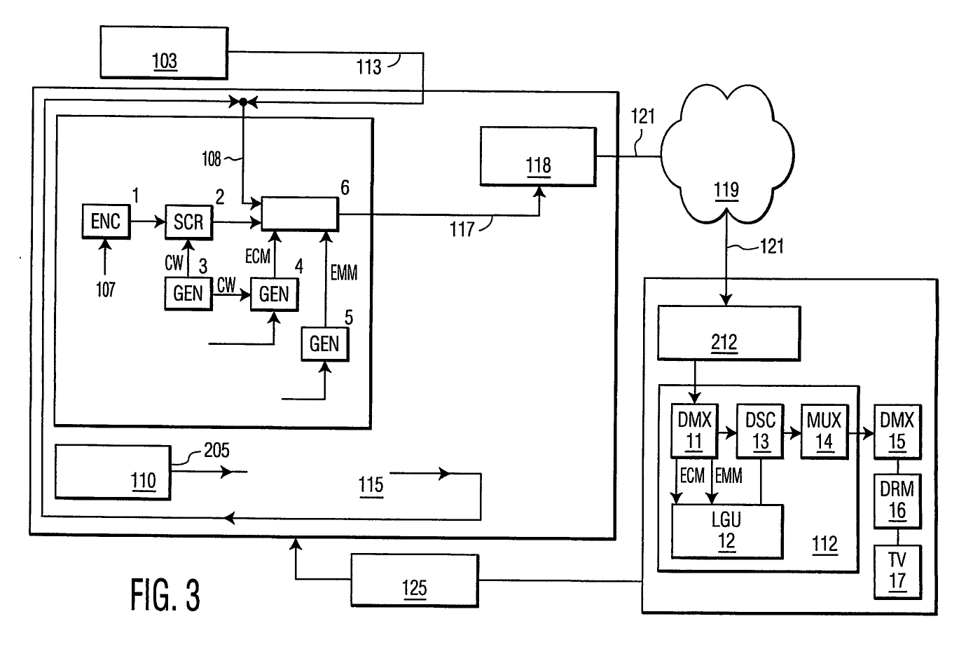

FIG. 3 is a more detailed block diagram of FIG. 1 including those components which facilitate or deny access to a broadcast;

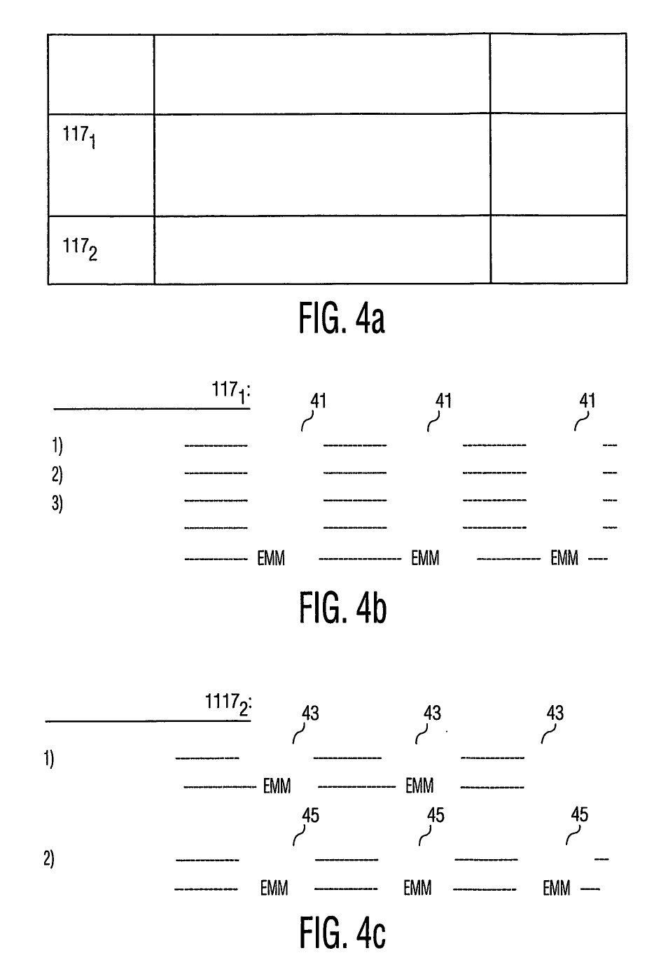

FIG. 4a is an exemplary illustration of two transport streams, wherein each transport stream includes a plurality of multiplexed services;

FIG. 4b is an exemplary illustration of a single transport stream owned by a single service provider in which the commercial segments of the multiplexed services are horizontally aligned;

FIG. 4c is an exemplary illustration of a single transport stream owned by two different service providers in which the commercial segments of the multiplexed services are not horizontally aligned; and

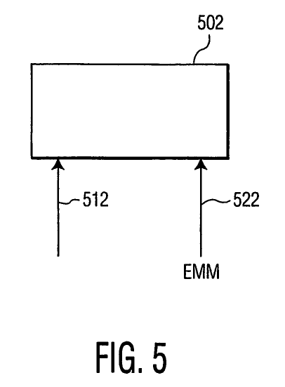

FIG. 5 is an illustration of a CA module modified in a manner to insure that a viewer is watching the correct service (TV channel).

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing limitations upon, the claimed invention.

The present invention is described in terms of television advertising, however, it is equally operative for advertising over the Internet, various forms of interactive television (e.g., WebTV, RealTV), Radio and Audio on Demand (e.g., Internet radio), and various forms of video and Video on Demand (including CATV, satellite, Internet Television, etc.).

FIG.1, illustrates a block diagram of one embodiment of a conditional access system 100.

Included in the embodiment of FIG. 1 is a broadcast station 101 coupled to receiver(s) 120A, 120B, 120C (referred to as 120) via a network 119 and optional back channel(s) 125A, 125B, 125C (referred to as 125). Integrated receiving devices 120 may comprise any number of suitable devices including a set-top box (STB), hybrid TV or digital TV. Further, broadcast station 101 is shown coupled to advertiser 103. A single advertiser is shown for ease of explanation. Broadcast station 101 includes programming sources 105, 106, broadcast server 110, multiplexer 116 and transmitter 118. Source 103 generates advertising content 113 and sources 105, 106 generate programming content 107, 108 which are multiplexed in multiplexer 116 to form transport stream 117, to be described further below with reference to FIG. 4. Broadcast server 110 maintains a database 112 of interactive applications 115. The various interactive applications 115 are associated with individual commercials supplied from advertiser 103. The interactive applications 115 are designed in such a way to ensure that a viewer (i.e., subscriber) 102A, 102B, 102C (referred to as 102) has watched and/or participated with a commercial broadcast. The broadcast server 110 associates particular interactive applications 115 with particular commercials supplied from the advertiser 103. While the interactive applications are optional, when used, they are multiplexed into transport stream 117.

Subsequent to its creation, programming content 107, 108, commercial segments 113 and optionally interactive applications 115 may be delivered to receiver(s) 120 through network 119. The broadcast signal 117 is broadcast via a transmitter 118 over transmission medium through the network 119 to the receivers 120. As used herein, a “broadcaster” 101 is any entity providing programming content that will be carried on a broadcast signal 121. The transmission medium may be a terrestrial cable, satellite, antenna(s) or any other transmission means.

The viewer's integrated receiver devices (IRD) 120 of FIG. 1 may be configured differently depending upon whether the intended broadcast market is a horizontal or vertical market.

Turning now to FIG. 2a, one embodiment of the integrated receiver device (IRD) 120 of FIG. 1 for use in a “horizontal” market, is shown. In a typical horizontal market, descrambling is broadcaster independent. That is, descrambling is performed by a CA module 216 connected to a common interface (CI) 214. The CI 214 permits the use of different CA modules from different vendors allowing broadcasters to use their own proprietary descrambling technique. Typically, the CI 214 is a PCMCIA slot in which a CA module 216 can be inserted. It is noted that in the United States, the CI 214 is commonly referred to as a point of deployment (POD).

The IRD 120 of FIG. 2a is configured to receive the broadcast signal 121 via network 119, and convey output information including video 224a, audio 224b, sub-titling 224c and teletext 224d information to a display 221 or recording device. In the embodiment shown, IRD 120 includes modem 210 for sending requests like EMM requests, back to broadcaster 101. The input signal 121 may be received over terrestrial lines, cable lines or via satellite at demodulator 212. The demodulated signal is output to the common interface (CI) module 214. Conditional Access module 216 is shown coupled to CI module 214 to perform descrambling when needed. The CI module 214 outputs a signal to demultiplexer 222 which separates the signal into respective signal components, such as video 224a, audio 224b, sub-titling 224c and teletext 224d for display on the display device 221. Middleware 220 represents the high level control and graphical user interface of the IRD 120. Applications 115 are interactive applications, such as, for example, Java applets commonly referred to as xlets. The applications 115 are often used in horizontal markets and are typically sent together with the programming contact 107, 108, as described above with reference to FIG. 1.

Turning now to FIG. 2b, one embodiment of the IRD device 120 of FIG. 1 is shown for use in a “vertical” market In contrast to the horizontal market in a typical vertical market, descrambling is broadcaster dependent. Typically, a broadcaster sells an IRD module 120, such as the one shown in FIG. 2b, specific to the broadcaster, thereby allowing the viewer access to the broadcaster's network. As shown, the IRD 120 of FIG. 2b contains a CA module that is closely connected to the DEMUX i.e., Demux/CA 222. In this manner, the cost of the IRD 120 is cheaper to produce than the IRD of FIG. 2a, however, the IRD 120 of FIG. 2b can only be used for one specific broadcaster. This situation is specific for use in “vertical” markets. As a further distinction between the IRDs of FIG. 2a and 2b, there is no application unit 115 shown in FIG. 2b. This occurs because vertical markets do not utilize downloadable applications like xlets, for example.

Prior to further describing the embodiments of the invention, it is instructive to look at another aspect of the conditional access system 100 of FIG. 1. In particular, a more detailed illustration will be provided of the conditional access system 100 of FIG. 1 describing those modules which facilitate or deny access to a broadcast.

As is well known, in a pay service arrangement between a broadcaster 101 and a plurality of subscribers 102, the subscribers 102 subscribe to a basic service upon payment of a subscription fee, commonly referred to as a ‘conditional access’ system. To enforce the payment of such fees, and to prevent unauthorized access from non-subscribers, the signal may be encoded by the broadcaster, and require some sort of de-scrambler to facilitate access to the information. The signal may be scrambled, encrypted, or otherwise locked from viewing until the user agrees to pay for access. When the user decides to obtain the television broadcast, the service provider (broadcaster) exchanges an electronic access key to the scrambled, encrypted, or otherwise locked data in exchange for agreement to his commercial terms.

FIG. 3 is a more detailed block diagram of FIG. 1 including those components which facilitate or deny access to broadcast. As is conventional in a conditional access system 100, the programming content 107, 108 to be broadcast, is encoded in encoder 1 using an appropriate coding system, for example MPEG-II for digital broadcasting. The encoded broadcast stream is encrypted or scrambled in a scrambler 2 under the control of a control word CW generated by a control word generator 3 in a manner which is well-known per se. The control word is encrypted into an Entitlement Control Message (ECM) by an ECM generator 4 together with access criteria which identify the service and the conditions required to access the service. For example, the access criteria may specify regional limitations on the broadcast. A further type of message, referred to as an Entitlement Management Message (EMM), which carries details of the subscriber and his subscription is generated by an EMM generator 5. While an ECM message is associated with a scrambled program or set of programs and carries the information required to decrypt those programs, an EMM message is a message dedicated to an individual user or group of users and carries the information necessary to determine whether those users have the necessary subscriptions in place to be able to view the programs.

The scrambled encoded broadcast stream (e.g., originating from programming content 107) together with the ECM and EMM messages is multiplexed in a multiplexer 6 with other broadcast streams (e.g., programming content 108 or originating therefrom). The package is sent to a transmitter 118 from which it is transmitted, via network 119. The scrambled encoded broadcast stream is received at a subscriber's integrated receiver device (IRED) 120. The IRD 120 serves to demodulate the broadcast signal 121 received from broadcast station 101 and to separate the components of the signal, such as different television programs and interactive applications.

On receipt at the receiver 120, the received and demodulated data is demultiplexed in a demultiplexer 11, which may be embodied as DMX 222 of FIG. 2a, to extract the required program and its associated ECM and EMM messages. The extracted ECM and EMM messages are sent to a logic control unit 12 which processes the incoming EMM's and ECM's along with requests from the client (e.g., descramble requests). The logic control unit 12 outputs control words required as input by the descrambler 13. The control word comprises alternating odd and even control words which are alternated at, for example, two second intervals. Each control word is changed at predetermined intervals, for example, every twenty seconds. A continuous stream of ECM messages is therefore required to descramble the scrambled signal. The EMM message can be updated less frequently.

Control unit 12 uses the ECM and EMM messages to determine whether the subscriber has the right to view the broadcast and if so, to decrypt the control word CW, which is input to a descrambler 13 together with the scrambled broadcast stream to recover the original MPEG-II encoded broadcast stream. The encoded stream is passed to a multiplexer 14 which outputs the multiplexed signal to demultiplexer 15 which in turn outputs the demultiplexed signal to a decoding and rendering module 16 which produces an output signal comprising audio, video and data components for display on the subscriber's television 17.

The conventional form of ECM and EMM messages is well known in the art, e.g., as defined in the international standard ISO IEC 13818-1, the entire contents of which are incorporated herein by reference.

In one embodiment, a viewer (subscriber) 102 is encouraged to watch the commercial segments (advertising content) 113 of a current broadcast by rewarding the viewer 102 with the opportunity to watch a subsequent program at no charge. To receive the reward, all that is required of the viewer 102 is to maintain his or her receiver 120 at the same station or channel during the commercial segments of the current broadcast. By maintaining the receiver 120 at the same station during the commercial segments, an EMM message is received at the receiver 120 enabling the receiver 120 to descramble a subsequent program, free of charge, as a reward to the viewer

In operation, the Broadcaster 101 sends the EMM message only during the commercial breaks or segments of a live television broadcast, as shown in FIG. 4b. As is well known, the EMM message is a necessary data element required by the viewer's IRD 120 to descramble a broadcasted program. By maintaining the IRD 120 to the same channel during the commercial segments or breaks, the EMM message transmitted by the broadcaster 101 will be received at the demultiplexer unit 11 of the viewer's receiver 120 thereby providing the means necessary to descramble a subsequent program as a reward to the viewer.

Referring now to FIG. 4a, there is shown an exemplary illustration of two transport streams 117₁ and 117₂, wherein each transport stream includes a plurality of multiplexed services. In particular, exemplary transport stream 117₁ is comprised of three multiplexed services 107₁, 108₁, and 109₁, and exemplary transport stream 117₂ is comprised of multiplexed services 107₂ and 108₂. A small number of multiplexed services are shown for ease of explanation. As shown in FIG. 4a, service provider 1 owns transport stream 117₁ in its entirety which includes multiplexed services 107₁, 108₁, 109₁. By contrast, the ownership of transport streams 117₂ is shared. For example, service provider 2 owns multiplexed service 107₂ and service provider 3 owns multiplexed service 108₂.

In the case where a single service provider owns the entire transport stream, (i.e., service provider 1) the service provider can insure that the commercial segments (breaks) of each multiplexed service in the stream are horizontally programmed (aligned) 41, as shown in FIG. 4b. In the case of horizontal alignment, a viewer may switch from any service to any other service within the same transport stream, e.g., from service 107₁, to 108₁, or from 109₁ to 107₁ and still be guaranteed to receive the EMM, thus satisfying the advertiser's requirements for receiving the reward.

In the more common case where a single transport stream is owned by different service providers, (i.e., service providers 2 and 3) there is no longer a guarantee that the respective multiplexed services which make up the transport stream will be horizontally programmed (aligned). This more common situation is illustrated in FIG. 4c. In particular, transport stream 117₂ is comprised of two multiplexed services. A first service 107₂ owned by service provider 2, and a second service 108₂ owned by service provider 3. As is conventional, there is no horizontal alignment of the commercial segments or breaks between the differently owned transport streams 107₂ and 108₂. As shown in FIG. 4c, commercial segments 43 are not horizontally aligned with commercial breaks 45. It therefore becomes necessary to provide some means of tracking that a viewer is watching the correct service (TV channel) of the transport stream. Otherwise, the viewer would simply receive the EMM regardless of which station is being viewed, in which case the viewer would be unjustly rewarded. It must be determined that the EMM being received is the EMM associated with the pre-determined channel of interest.

One approach for insuring that the viewer is watching the correct service is to extend the CA module with some additional functionality, as will be described now with reference to FIG. 5.

FIG. 5 illustrates a CA module 502 modified in a manner to insure that a viewer is watching the correct TV channel in the case where multiple service providers provide commercial breaks at unpredictable intervals. In particular, a first input signal 512 is provided to the CA module 502 informing the CA module which of the multiplexed services (IV channels) is currently being viewed by the viewer. A second input signal 522 provided to the CA module 502 is the EMM which includes additional information specifying the channel which must be viewed in order to receive the reward from the advertiser. The modified CA module 502 operates by only storing the EMM in the case where the channel information included in the EMM (i.e., the channel which must be watched) matches the channel currently being watched by the viewer. In other words, the EMM is stored only in the case of a match between the viewed and the pre-determined channel thus guaranteeing that the viewer is watching the commercial segments of the predetermined channel.

A shortcoming of the previous embodiment is that it is quite common for viewers 102 to leave during commercials or other breaks and return shortly thereafter. While the user's receiver may be tuned to the appropriate channel, the viewer may be elsewhere. This situation is undetectable in the first embodiment. One manner of detecting the actual presence of viewers, which overcomes the problem of a viewer's IRD 120 being appropriately tuned while the viewer is not present, is described in the present embodiment. That is, the present embodiment provides a solution to the question: Is the viewer in fact actually present in the room and watching the commercial segment?

In accordance with the present embodiment, the viewer is required to participate or interact in some manner with the commercial segment to insure the viewer's presence. Interaction with the commercial segment may take any number of forms including, for example:
Filling in an electronic form including a viewer's profile to be transmitted to the content provider.
Requiring the viewer to play a game related to the product being endorsed in the commercial segment.
Requesting that the viewer fill in a barcode, or any other suitable code that is uniquely related to an already purchased product, to be transmitted back to the content provider via the back channel 125. Alternatively, in the case where a back channel is not utilized, the viewer would not be required to transmit the barcode information back to the content provider but could instead report the code to the content provider via a voice response system or consumer help desk, for example.
Clicking the remote controller in response to prompts from the television set or from the set-top box unit, once or several times.
Requesting that the viewer rate the commercial segment based on a variety of factors.

In this manner, a broadcast sponsor (i.e., commercial advertiser) is assured that the viewer is present and attentive to the commercial broadcast.

In each of the described embodiments, the number of EMM messages that must be received to qualify for the reward may be preferably determined by the sponsor. In the most stringent case, a sponsor may require the viewer to view each commercial segment which corresponds to receiving the EMM message transmitted during each commercial break. In other scenarios, the number of commercial segments (e.g., N) which must be viewed may vary dependent upon the level of viewer attention demanded by the sponsor. As one example, a sponsor may require the viewer to view at least N=4 commercial segments corresponding to receiving 4 EMM messages. It is noted that in certain embodiments, a single received EMM message, i.e., N=1, may qualify the viewer to receive the reward. An EMM counter may be used to count the number of received EMM messages and compare the total against an EMM threshold.

It should be noted that the previous description of the preferred embodiments is provided to enable any person skilled in the art to make or use the present invention. The various modifications to these embodiments will be readily apparent to those skilled in the art, as well as other embodiments, without the use of the inventive faculty. Thus, the present invention is not intended to be limited to the embodiments shown herein but is to be accorded the widest scope consistent with the principles and novel features disclosed herein.

1. A method for encouraging a viewer (102) to watch the commercial segments of a pre-determined channel, the pre-determined channel included as part of a broadcast signal (121) transmitted to a plurality of integrated receiver devices (IRDs) (120) belonging to respective viewers (102), the broadcast signal (121) being comprised of a plurality of channels grouped as one or more transport streams (117), each of said plurality of channels comprising programming content (107, 108) interspersed with commercial segments (113) and entitlement management messages (EMMs), the EMMs transmitted substantially coincident in time with the commercial segments, the method comprising the acts of:
(a) receiving the broadcast signal (121) at a viewer's IRD (120);
(b) determining whether the viewer's IRD (120) is tuned to the pre-determined channel during a time substantially coincident with the broadcast of at least N commercial segments associated with said pre-determined channel;
(c) rewarding the viewer (102) when said determining act (b) is satisfied.

2. The method of claim 1, wherein the determining act (b) further comprises the acts of:
i.) initializing an EMM counter,
ii.) during the broadcast of an i^{th} commercial segment of a viewed channel:
1. determining the identity of the viewed channel;
2. determining the identity of a pre-determined channel required to be viewed for receiving the reward;
3. comparing the identity of the viewed channel with the identity of the pre-determined channel;
4. storing the EMM when there is a match at said comparison step;
5. incrementing the EMM counter when there is a match at said comparison step; and
6. proceeding to act (c) of claim 1 when the EMM counter is equal to a pre-determined threshold count N, otherwise repeating acts (1) through (6) for an (i+1)^{th} commercial segment of the viewed channel.

3. The method of claim 1, wherein the rewarding act (c) further comprises the act of using the previously stored EMM and an ECM (Entitlement Control Message) to generate a control word to descramble at least one future scrambled television program free of charge to the viewer (102).

4. The method of claim 1, wherein the broadcast signal (121) is distributed over one of a wireless and/or wired system.

5. The method of claim 1, further comprising the act of determining whether the viewer (102) is watching the pre-determined channel during the time substantially coincident with the broadcast of at least one commercial segment associated with the pre-determined channel.

6. The method of claim 5, wherein said determination act further comprises the acts of:
requiring the viewer (102) to fill in an electronic form including the viewer's profile during the time substantially coincident with the broadcast of an i^{th} commercial segment associated with the pre-determined channel; and
transmitting the filled out electronic form back to a content provider (101).

7. The method of claim 5, wherein said determination act further comprises the act of requiring the viewer (102) to participate interactively, via an interactive application (115), to a product being endorsed during the time substantially coincident with the broadcast of an i^{th} commercial segment associated with the pre-determined channel.

8. The method of claim 5, wherein said determination act further comprises the acts of:
requiring the viewer (102) to fill in a barcode, or any other suitable code, that is uniquely related to an already purchased product being endorsed during the time substantially coincident with the broadcast of an i^{th} commercial segment associated with the pre-determined channel; and
transmitting the filled out barcode back to a content provider (101).

10. The method of claim 6, wherein said determination act further comprises the act of requiring the viewer (102) to respond in some manner to one or more prompts during the time substantially coincident with the broadcast of an i^{th} commercial segment associated with the pre-determined channel.

11. The method of claim 6, wherein said determination act further comprises the act of requesting that the viewer (102) rate the i^{th} commercial segment during the time substantially coincident with the broadcast of an i^{th} commercial segment associated with the pre-determined channel.

12. A method for encouraging a viewer (102) to watch the commercial segments of a pre-determined channel, the pre-determined channel included as part of a broadcast signal (121) transmitted to a plurality of integrated receiver devices (IRDs) (120) belonging to respective viewers (102), the broadcast signal (121) being comprised of a plurality of channels grouped as one or more transport streams (117), each of said plurality of channels comprising programming content (107, 108) interspersed with commercial segments (113) and entitlement management messages (EMMs), the EMMs transmitted substantially coincident in time with the commercial segments, the method comprising the acts of:
(a) receiving the broadcast signal (121) at a viewer's IRD (120);
(b) determining whether the viewer's IRD (120) is tuned to a pre-determined transport stream during a time substantially coincident with the broadcast of at least N commercial segments associated with said pre-determined transport stream;
(c) rewarding the viewer (102) when said determining act is satisfied.

13. The method of claim 12, wherein the determining act comprises the act of receiving and storing the EMMs transmitted substantially coincident in time with the commercial segments.

14. The method of claim 12, wherein the rewarding act further comprises the act of using the previously stored EMM and an Entitlement Control Message (ECM) to generate a control word to descramble a future scrambled television program free of charge to the viewer (102).

15. The method of claim 12, wherein the broadcast signal (121) is distributed over one of a wireless and/or wired system.

16. A television broadcast system (100), comprising a television broadcast station (101) for transmitting a broadcast signal (121) comprising a plurality of channels grouped as one or more transport streams (117), each of said plurality of channels comprising programming content (107, 108) interspersed with commercial segments (113) and entitlement management messages (EMMs), the EMMs transmitted substantially coincident in time with the commercial segments, the system comprising:
a broadcast station (101) comprising:
a broadcast server (110) for providing interactive applications (115);
at least one source (105, 106) of said programming content (107, 108);
a multiplexer (116) for combining said commercial segments (113), programming content (107, 108) and optionally interactive applications (115) to form said transport stream (117);
a transmitter (118) for transmitting said transport stream (117) as said broadcast stream (121) over a transmission medium (119); and
an integrated receiver device (IRD) (120) comprising:
a conditional access (CA) module for determining whether a viewer (102) is watching a channel corresponding to a predetermined channel and for storing entitlements, each stored entitlement corresponding to an i^{th} commercial segment associated with the pre-determined channel.
